(19) United States
(12) Patent Application Publication
(10) Pub. No.: US 2009/0207211 A1
(43) Pub. Date: Aug. 20, 2009

(54) LIQUID JET HEAD AND A LIQUID JET APPARATUS

(75) Inventor: Sukehiro Ito, Matsumoto (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/361,225

(22) Filed: Jan. 28, 2009

(30) Foreign Application Priority Data
Jan. 28, 2008 (JP) 2008-015890

(51) Int. Cl. B41J 2/045

(52) U.S. Cl. 347/68

(57) ABSTRACT

A liquid jet head includes: a pressure generation chamber 11 communicating with a nozzle opening 13 ejecting a liquid; a piezoelectric element 17 causing pressure change inside the pressure generation chamber 11; a case head 20 having an accommodation portion 19 accommodating the piezoelectric element 17; and a flexible printed board 50 having a driving circuit 60 mounted thereon and connected to the piezoelectric element 17 to drive the piezoelectric element 17. The accommodation portion 19 of the case head 20 is provided with a flow passage member 21 holding a base end portion of the piezoelectric element 17 and being connected to the driving circuit 60 in a thermally conductive manner, the case head 20 is provided with a liquid introduction passage 30 for supplying the liquid to the pressure generation chamber 11, and the flow passage member 21 partitions a part of at least a wall surface of the liquid introduction passage 30.

### BACKGROUND OF THE INVENTION

The entire disclosure of Japanese Patent Application No. 2008-015890, filed Jan. 28, 2008 is incorporated by reference herein.

### FIELD OF THE INVENTION

The present invention relates to a liquid jet head and a liquid jet apparatus capable of ejecting a liquid from nozzle openings, and particularly to an ink jet recording head and an ink jet recording apparatus capable of ejecting ink.

### INVENTION OF THE RELATED ART

As a typical example of a liquid jet head, for example, there is known an ink jet recording head that ejects ink droplets from nozzle openings by using pressure change caused by displacement of piezoelectric elements. Specifically, as disclosed in JP-A-2004-74740, an ink jet recording head is known which includes: a flow passage unit that has a flow passage forming plate having therein pressure generation chambers, which individually communicate with nozzle openings, and a vibration plate provided on one surface of the flow passage forming plate; a nozzle plate that has the nozzle openings and is bonded to the flow passage unit by an adhesive; piezoelectric elements (piezoelectric vibrators) that are arranged so as to individually correspond to the pressure generation chambers and are fixed to a support board; and a case head (a base) having therein an accommodation chamber for accommodating therein the piezoelectric elements.

A driving circuit that inputs a driving signal for driving the piezoelectric elements is mounted on a flexible printed circuit board, and the driving signal from the driving circuit is applied to the piezoelectric elements through the flexible printed circuit board.

However, since only the driving circuit mounted on the flexible printed circuit board is able to dissipate heat from the driving circuit, the heat dissipation ability is restrained. When a circuit loss exceeds the heat dissipation ability, the driving circuit may be destroyed by heat. Moreover, since a large heat dissipation area is required for securing the heat dissipation properties, a problem may occur in that it is difficult to reduce the size of the driving circuit.

In particular, when the driving circuit is provided inside the case head as disclosed in Patent Document 1, the driving circuit is just able to dissipate heat within the case head and unable to dissipate the heat to the atmosphere, thereby increasing the temperature of the driving circuit.

These problems are similarly found in other liquid jet heads ejecting liquid other than ink as well as the ink jet recording head.

### SUMMARY OF THE INVENTION

The present invention is devised in view of such a circumstance, and an object of the present invention is to provide a liquid jet head and a liquid jet apparatus capable of effectively dissipating heat from a driving circuit, achieving miniaturization and low cost for the driving circuit, and improving the durability of the driving circuit, thereby improving liquid ejection characteristics.

In order to solve the above-mentioned problems, according to an aspect of the invention, there is provided a liquid jet head including: a pressure generation chamber communicating with a nozzle opening ejecting a liquid; a piezoelectric element causing pressure change inside the pressure generation chamber; a case head having an accommodation portion accommodating the piezoelectric element; and a flexible printed board having a driving circuit mounted thereon and connected to the piezoelectric element to drive the piezoelectric element. The accommodation portion of the case head is provided with a flow passage member holding a base end portion of the piezoelectric element and being connected to the driving circuit in a thermally conductive manner, the case head is provided with a liquid introduction passage for supplying the liquid to the pressure generation chamber, and the flow passage member partitions a part of at least a wall surface of the liquid introduction passage.

According to this aspect, the heat of the driving circuit can be allowed to be thermally conductive to the flow passage member partitioning the liquid instruction passage and the flow passage member can be cooled (heat-dissipated) by the liquid flowing in the liquid introduction passage. With such a configuration, it is possible to prevent the driving circuit from being broken down due to the heat. Moreover, it is possible to reduce the size of the driving circuit without increase in the driving circuit and thus reduce the cost. Furthermore, it is possible to improve durability of the driving circuit by suppressing the lifetime of the driving circuit from being shortened due to the heat and improve a liquid ejection characteristic and an ability in continuous ejection of a liquid.

It is preferable that the flow passage member is formed of a material having thermal conductivity higher than that of the case head. Accordingly, it is possible to effectively suppress the heat dissipation of the driving circuit by effectively allowing the heat of the driving circuit to be thermally conductive to the flow passage member.

It is preferable that the liquid introduction passage is partitioned by a groove portion opened to a side surface of the accommodation portion of the case head and the flow passage member blocking the groove portion. Moreover, it is preferable that the liquid introduction passage is perforated through the flow passage member. With such a configuration, it is possible to cool (dissipate the heat of) the flow passage member by use of the liquid.

According to another aspect of the invention, there is provided a liquid jet apparatus that includes the liquid jet head according to the above-mentioned aspect.

According to such an aspect, it is possible to realize the liquid jet apparatus that is improved in reliability and can be manufactured at low cost.

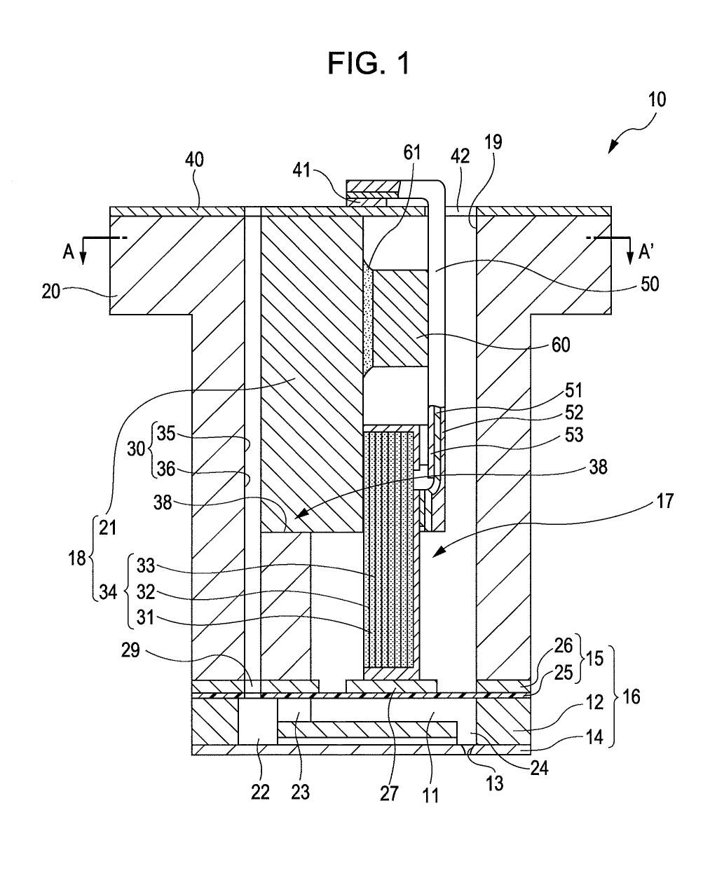

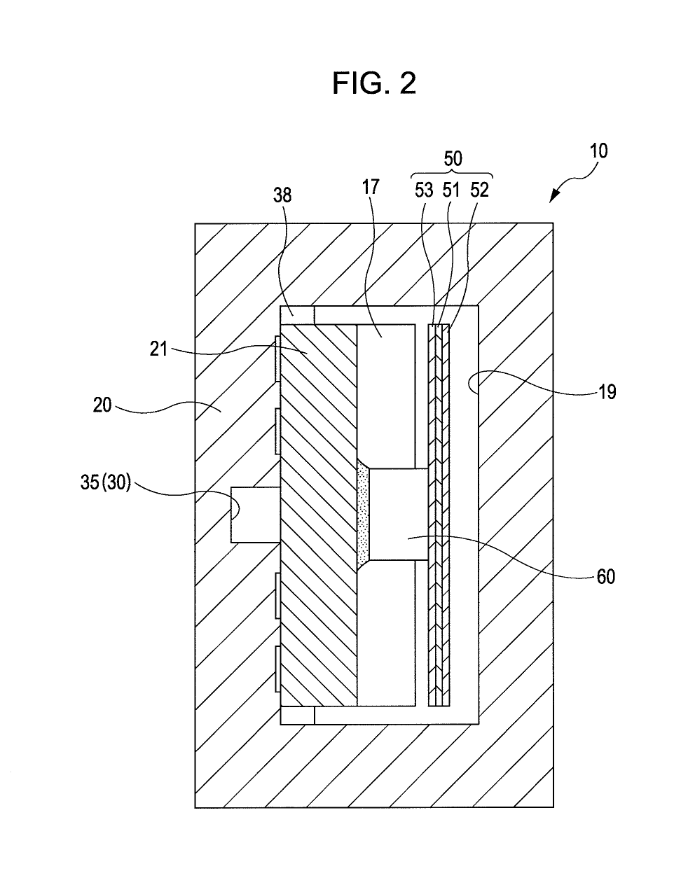

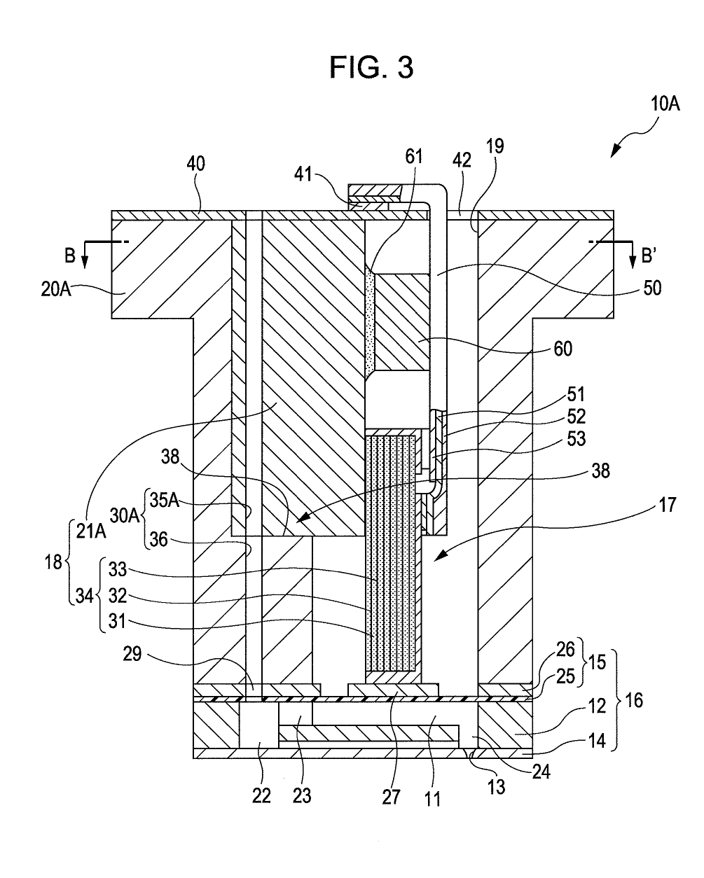

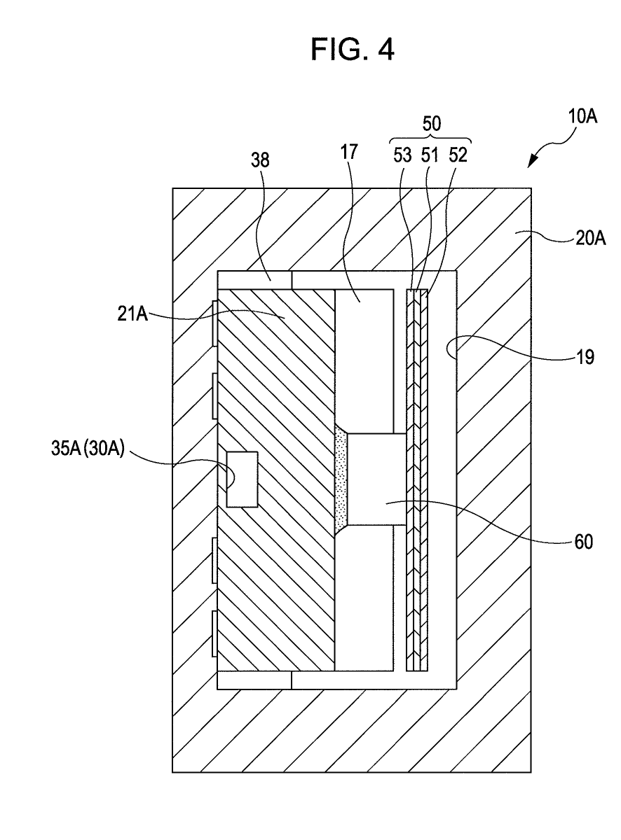

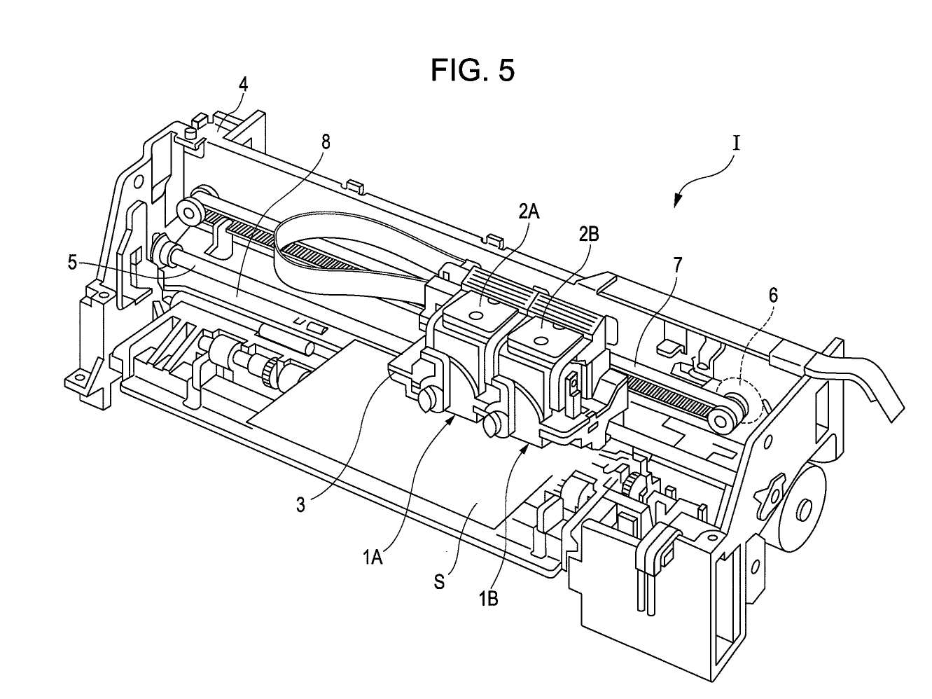

### BRIEF DESCRIPTION OF THE DRAWINGS

[FIG. 1] FIG. 1 is a sectional view illustrating a liquid jet head according to a first embodiment of the invention.

[FIG. 2] FIG. 2 is a sectional view illustrating the liquid jet head according to the first embodiment of the invention.

[FIG. 3] FIG. 3 is a sectional view illustrating a liquid jet head according to a second embodiment of the invention.

[FIG. 4] FIG. 4 is a sectional view illustrating the liquid jet head according to the second embodiment of the invention.

[FIG. 5] FIG. 5 is a schematic diagram illustrating an ink jet recording apparatus according to an aspect of the invention.

I: INK JET RECORDING APPARATUS (LIQUID JET APPARATUS)

10, 10A: INK JET RECORDING HEAD (LIQUID JET HEAD)

11: PRESSURE GENERATION CHAMBER

12: PASSAGE FORMING BOARD

13: NOZZLE OPENING

14: NOZZLE PLATE (ADHESIVE MEMBER)

15: VIBRATION PLATE

16: FLOW PASSAGE UNIT

17: PIEZOELECTRIC ELEMENT

18: PIEZOELECTRIC ELEMENT UNIT

19: ACCOMMODATION PORTION

20, 20A: CASE HEAD

21, 21A: FLOW PASSAGE MEMBER

30, 30A: INK INTRODUCTION PASSAGE (LIQUID INTRODUCTION PASSAGE)

40: WIRING BOARD

50: FLEXIBLE PRINTED BOARD

60: DRIVING CIRCUIT

### DESCRIPTION OF THE PREFERRED EMBODIMENTS

Hereinafter, embodiments of the invention will be described in detail.

### First Embodiment

FIG. 1 is a sectional view illustrating an ink jet recording head that is an example of a liquid jet head according to a first embodiment of the invention. FIG. 2 is a sectional view taken along the line A-A′ in FIG. 1.

As illustrated in the drawings, an ink jet recording head 10 has a flow passage unit 16 that is provided with a flow passage forming board 12 having a plurality of pressure generation chambers 11, a nozzle plate 14 in which a plurality of nozzle openings 13 is formed to individually communicate with the pressure generation chambers 11, and a vibration plate 15 that is provided on a surface of the flow passage forming board 12 opposite to the nozzle plate 14. In addition, the ink jet recording head is provided with a piezoelectric element unit 18 that has piezoelectric elements 17 being provided on an area of the vibration plate 15 and individually corresponding to the pressure generation chambers 11, a case head 20 that has an accommodation portion 19 being fixed on the vibration plate 15 and accommodating the piezoelectric element unit 18 therein, and a flow passage member 21 that is provided in the accommodation portion 19 of the case head 20.

In the flow passage forming board 12, the plurality of pressure generation chambers 11 are partitioned by partition walls on a surface portion on one surface side thereof and arranged in parallel in a width direction thereof. Outside the row of the pressure generation chambers 11, a reservoir 22 supplied with ink through an ink introduction passage 30 that is a liquid introduction passage of the case head 20 and the flow passage member is provided so as to perforate through the flow passage forming board 12 in a thickness direction thereof. The reservoir 22 and the respective pressure generation chambers 11 communicate with each other through an ink supply passage 23, so that ink is supplied to the respective pressure generation chambers 11 through the ink introduction passage 15, the reservoir 22 and the ink supply passage 23. In this embodiment, the ink supply passage 30 is formed with a width smaller than that of the pressure generation chamber 11, thereby serving as maintaining a constant flow passage resistance for the ink introduced from the reservoir 22 to the pressure generation chambers 11. Moreover, a nozzle communication hole 24 is formed on an end of each of the pressure generation chambers 11 opposite to the reservoir 22 so as to perforate through the flow passage forming board 12. That is, in this embodiment, the flow passage forming board 12 is provided with the pressure generation chambers 11, the reservoir 22, the ink supply passage 23, and the nozzle communication hole 24 as a liquid flow passage. In this embodiment, such a flow passage forming board 12 is formed of a single-crystalline silicon substrate, and the pressure generation chambers 11 provided in the flow passage forming board 12 and the like are formed by etching the flow passage forming board 12.

The nozzle plate 14 through which the nozzle openings 13 are punched is bonded to the one surface of the flow passage forming board 12, and the nozzle openings 13 individually communicate with the pressure generation chambers 11 through the nozzle communication holes 24 that are provided in the flow passage forming board 12.

On the other hand, the vibration plate 15 is bonded to the other surface of the flow passage forming board 12, that is, the opening surface of the pressure generation chambers 11, and the pressure generation chambers 11 are sealed by the vibration plate 15.

The vibration plate 15 is formed of a composite plate that is composed of an elastic film 25 formed of an elastic member such as a resin film and a support plate 26 that supports the elastic film 25 and is formed of a metal material, for example. The elastic film 25 is bonded to the flow passage forming board 12. For example, in this embodiment, the elastic film 25 is formed of a PPS (polyphenylene sulfide) film having a thickness of several μm, and the support plate 26 is formed of a stainless steel plate (SUS) having a thickness of several tens of μm. In addition, within an area of the vibration plate 15 opposite each of the pressure generation chambers 11, an island portion 27 is provided so that a front end portion of each of the piezoelectric elements 17 makes abutting contact therewith. A front end face of each of the piezoelectric elements 17 is bonded to the island portion 27 by an adhesive. An ink introduction port 29 formed to perforate through the support plate 26 is provided an area of the vibration plate 15 opposite the reservoir 22. In addition, the ink supplied from the ink introduction passage 30 of the case head 20 and the flow passage member 21 is supplied to the reservoir 22 through the ink introduction port 29. A compliance portion (not shown) that is substantially formed only of an elastic film 25 because of removal of the support plate 26 by etching is provided in areas other than the ink introduction port 29 in the area of the vibration plate 15 opposite the reservoir 22, that is, on both sides in a parallel arrangement direction of the pressure generation chambers 11 of the ink introduction port 29. In addition, the compliance portion serves as constantly maintaining the pressure inside the reservoir 22 by absorbing pressure change by deformation of the elastic film 25 of the compliance portion, when the pressure change occurs inside the reservoir 22.

Now, the piezoelectric elements 17 as a pressure generation unit that generate pressure for ejecting ink droplets in the pressure generation chambers 11 will be described. In this embodiment, the piezoelectric elements 17 are integrally formed in one piezoelectric element unit 18. That is, a piezoelectric material 31 and electrode forming materials 32 and 33 are longitudinally alternately stacked in a sandwich manner to form a piezoelectric element forming member 34, and the piezoelectric element forming member 34 is divided in a comb-teeth shape so as to correspond to each of the pressure generation chambers 11. In this way, the respective piezoelectric elements 17 are formed. That is, in this embodiment, a plurality of the piezoelectric elements 17 is integrally formed one another. An inactive area that does not contribute to vibration of the piezoelectric elements 17 (the piezoelectric element forming member 34), that is, the base end portion of the piezoelectric elements 17, is fixed and attached to the flow passage member 21 partitioning a part of the ink instruction passage 30 that is described below in detail, so that the piezoelectric elements 17 are fixed to the case head 20 with the flow passage member 21 interposed therebetween. In this embodiment, the piezoelectric elements 17 (the piezoelectric element forming member 34) and the flow passage member 21 form the piezoelectric element unit 18.

In the piezoelectric element unit 18, the front end portions of the piezoelectric elements 17 are fixed to come in contact with the island portion 27 of the vibration plate 15, as described above. For example, in this embodiment, as described above, the case head 20 is fixed onto the vibration plate 15, the piezoelectric element unit 18 is accommodated in the accommodation portion 19 of the case head 20, and the flow passage member 21 to which the piezoelectric elements 17 are fixed is fixed to the case head 20 opposite to the piezoelectric elements 17. Specifically, the case head 20 is bonded on the vibration plate 15, and the accommodation portion 19 is provided in an area that opposes the island portion 27 one another. Moreover, a step portion 38 is provided on a side of the ink introduction port 29 of the accommodation portion 19 of the case head 20. The flow passage member 21 is fixed to the step portion 38 of the case head 20, so that the piezoelectric element unit 18 is fixed to the inside of the case head 20.

The case head 20 is provided with the ink introduction passage 30 that is a liquid introduction passage for supplying ink from ink storage means such as an external ink tank or an ink cartridge to the reservoir 22. At least a part of the wall surface of the ink introduction passage 30 is partitioned by the flow passage member 21 holding the base end portion of each of the piezoelectric elements 17. That is, the ink introduction passage 30 is formed by the case head 20 and the flow passage member 21. Specifically, in the case head 20, a groove 35 opened toward the accommodation portion 19 in the inner surface provided with the step portion 38 of the accommodation portion 19 and a communication hole 36 formed to communicate with a groove on the side of the flow passage forming board 12. In addition, the flow passage member 21 is fixed to the step portion 38 of the case head 20 to block an opening of the accommodation portion 19 of the groove 35 and partitions a part of the ink introduction passage 30, that is, in this embodiment, the ink introduction passage 30 is formed by the groove 35 blocked by the flow passage member 21 and the communication hole 36.

A flexible printed board 50 mounted with a driving circuit being electrically connected to the piezoelectric elements 17 and driving the piezoelectric elements 17 is provided inside the accommodation portion 19 of the case head 20.

The flexible printed board 50 is formed of a flexible printed circuit (FPC), a tape carrier package (TCP), or the like. Specifically, for example, the flexible printed board 50 is made by forming wiring layers 51 being formed of thin copper on the surface of a base film 52 such as polyimide and having a predetermined pattern and by covering an area other than an area connected to other wirings, such as a terminal portion connected to the piezoelectric elements 17 of the wiring layer 51, with an insulating material 53 such as resist.

A base end portion of the respective wiring layers 51 of the flexible printed board 50 is connected to the electrode forming materials 32 and 33 forming the piezoelectric elements 17 by soldering or an anisotropic conductive member, for example. On the other hand, a front end portion of each of the wring layers 51 is electrically connected to a conductive pad 41 of a wiring board 40 provided in the case head 20, which is described below in detail.

A driving circuit 60 driving the piezoelectric elements 17 is mounted on the wiring layer 51 of the flexible printed board 50. The driving circuit 60 is mounted on an area opposite the flow passage member 21 of the flexible printed board 50. In addition, the driving circuit 60 and the flow passage member 21 are connected to each other in the thermally conductive manner, that is, thermally connected to each other. Here, a state where the driving circuit 60 and the flow passage member 21 are connected (thermally connected) to each other in the thermally conductive manner means a state where the both are in contact with each other or the both are adhered to each other by an adhesive or the like. That is, the driving circuit 60 and the flow passage member 21 may be in contact with each other or adhered to each other by an adhesive or the like.

When the driving circuit 60 and the flow passage member 21 are connected to each other in the thermally conductive manner, the driving circuit and the flow passage member may be connected to each other by urging means such as a spring or a rubber allowing the driving circuit 60 to be urged toward the flow passage member 21 or fixing means such as a clip, so that the connection state is not released. In addition, when the driving circuit 60 and the flow passage member 21 is adhered to each other by an adhesive, it is preferable that a material having relatively high thermal conductivity is used as the adhesive. As an example of the adhesive having the high thermal conductivity, an adhesive formed by kneading an electro-thermal filler made of a silicon material can be used. In this embodiment, as shown in FIG. 1, the driving circuit 60 and the flow passage member 21 are joined to each other by an adhesive 61 formed by kneading the electro-thermal filler. Accordingly, the thermal connection state can be surely prevented from being released due to a gap occurring between the driving circuit 60 and the flow passage member 21 due to the movement of the carriage, when the ink jet recording head 10 mounted on a carriage is moved in a main scanning direction.

An example of the driving circuit 60 includes a circuit board and a semiconductor integrated circuit (IC). Moreover, the driving circuit 60 is mounted on the wiring layers 51 of the flexible printed circuit board 50 by flip-mounting, for example. Further, in mounting the driving circuit 60 on the flexible printed circuit board 50, metal connections, such as gold (Au)—gold (Au) connections or gold (Au)—tin (Sn) connections, ACF (anisotropic conductive paste), ACP (anisotropic conductive film), solder bump connections, and the like can be used.

As a material of the flow passage member 21 connected to the driving circuit 60 in the thermal transfer manner, it is preferable that a material having high thermal conductivity, that is, a material such as aluminum, copper, iron, and stainless steel having a high dissipation property is used. In order to reduce the weight and manufacture cost of the ink jet recording head 10, it is preferable that the case head 20 is made of a resin material and the flow passage member 21 may be made of a material having at least thermal conductivity higher than that of the case head 20. Moreover, it is preferable that the flow passage member 21 and the case head 20 are joined to each other by an adhesive in order to prevent ink from leaking from the groove 35 forming the ink introduction passage 30.

The piezoelectric element unit 18 is formed by incorporating the flow passage member 21 with the piezoelectric elements 17. The piezoelectric element unit 18 is positioned and fixed to the case head 20 in the incorporated state. In this case, the piezoelectric elements 17 of the piezoelectric element unit 18 are positioned with respect to the vibration plate 15 (the island portion 27) by the outer circumferential surface of the flow passage member 21 and the inner surface of the accommodation portion 19 of the case head 20. In this way, it is possible to position the piezoelectric element unit 18 with ease and with high precision, compared to a case where the positioning is performed by directly grasping the piezoelectric elements 17 that are a brittle material. That is, the flow passage member 21 partitions the part of the ink introduction passage 30 as the liquid introduction passage and also serves as a member holding and positioning the piezoelectric elements 17.

Furthermore, the wiring board 40 having thereon the plurality of conductive pads 41 individually connected to the wiring layers 51 of the flexible printed circuit board 50 is fixed onto the case head 20. The accommodation portion 19 of the case head 20 is substantially blocked by the wiring board 40. On the wiring board 40, a slit-shaped opening 42 is formed on an area thereof opposite the accommodation portion 19 of the case head 20, the flexible printed circuit board 50 is drawn out from the opening portion 42 of the wiring board 40 to the outside of the accommodation portion 19, and the drawn-out region is curved and connected to the conductive pads 41.

In the ink jet recording head 10, when ink droplets are ejected, the volume of each of the pressure generation chambers 11 is changed by deformation of the piezoelectric elements 17 and the vibration plate 15, so that ink droplets are ejected from predetermined nozzle openings 13. Specifically, when ink is supplied from a liquid storage unit (not shown) to the reservoir 22 through the ink introduction passage that is the liquid introduction passage, the ink is distributed to the pressure generation chambers 11 through the ink supply passage 23. Then, by turning on/off application of voltage to predetermined piezoelectric elements 17 in accordance with the driving signal from the driving circuit 60, the piezoelectric elements 17 are caused to be contracted or expanded and pressure change is caused in each of the pressure generation chambers 11, thereby ejecting ink from the nozzle openings.

In the ink jet recording head 10, it is possible to dissipate the heat of the driving circuit 60 not only from the surface of the driving circuit 60 but also from the flow passage member 21, by connecting the driving circuit 60 to the flow passage member 21 partitioning the part of the ink introduction passage 30 as the liquid introduction passage in the thermally conductive manner. That is, since the flow passage member 21 partitions the ink introduction passage 30 and thus is in contact with the ink, the flow passage member 21 is cooled (heat-dissipated) by the ink. Accordingly, the heat transferred from the driving circuit 60 can be effectively dissipated by the flow passage member 21. In this way, it is possible to prevent the driving circuit 60 from being broken down due to the heat. Moreover, it is possible to reduce the size of the driving circuit without increase in the size thereof, since the heat dissipation property of the driving circuit 60 is improved. Furthermore, since the inner resistance of the driving circuit 60 needs to be reduced in order to suppress the heat of the driving circuit 60, the size of transistors inside the driving circuit 60 has to be ensured. However, since the driving circuit 60 is connected to the flow passage member 21 partitioning the part of the ink introduction passage 30 in the thermally conductive manner and thus the heat of the driving circuit 60 can be dissipated by the flow passage member 21 (ink), it is not necessary to reduce the size of the transistors. Accordingly, it is possible to reduce the size and cost of the driving circuit 60 without reducing the inner resistance of the driving circuit 60.

Since the heat of the driving circuit 60 can be suppressed by connecting the driving circuit 60 to the flow passage member 21 partitioning the part of the ink introduction passage 30 in the thermally conductive manner, an ink ejection property can be improved and an ability in continuous ejection of ink can be also improved by increasing current to be applied to the driving circuit 60. That is, when the heat of the driving circuit 60 is improved by increasing the current and heat dissipation time is shortened by continuously ejecting the ink, the current flowing in the driving circuit 60 or the ability in continuous ejection of ink is restrained. However, by allowing the flow passage member 21 to dissipate the heat of the driving circuit 60, it is possible to increase the current flowing in the driving circuit 60 and to perform the continuous ejection of ink at a short interval for a long time.

Moreover, by connecting the driving circuit 60 to the flow passage member 21 partitioning the part of the ink introduction passage 30 in the thermally conductive manner, it is possible to heat ink contacting to the flow passage member 21. Accordingly, since the viscosity of the ink is lowered due to the heating of the ink, it is possible to eject the ink having high viscosity from the ink jet recording head 10. That is, since the viscosity of the ink having the high viscosity can be lowered by heating the ink having the high viscosity by use of the heat of the driving circuit 60 through the flow passage member 21, it is possible to eject the ink with the same ejection characteristic as that of normal viscosity. In a case of a temperature range set as a driving condition accompanied with the ink viscosity of the piezoelectric elements 17, for example, in a case of a temperature range from 0° C. to 40° C., the temperature of 0° C. can be increased. Accordingly, since a restraint on the driving condition is broader and thus the ink can be ejected with a desired ejection characteristic, it is possible to realize high quality printing.

### Second Embodiment

FIG. 3 is a sectional view illustrating an ink jet recording head as an example of a liquid jet head according to a second embodiment of the invention. FIG. 4 is a sectional view taken along the line B-B′ of FIG. 3. The same reference numerals are given to the same constituent elements as those according to the above-described first embodiment, and repeated description is omitted.

As illustrated in the drawings, an ink jet recording head 10A according to this embodiment includes a case head 20A and a flow passage member 21A accommodated in an accommodation portion 19 of the case head 20A. The case head 20A is provided with only a communication hole 36 on a side of a flow passage forming board 12. A step portion 38 of the case head 20A is formed up to a location where the bottom surface of the communication hole 36 is opened. The flow passage member 21A fixed to the step portion 38 is provided with a through-hole 35A communicating the communication hole 36. An ink introduction passage 30A as a liquid introduction passage supplying ink to a reservoir 22 includes the through-hole 35A formed in the flow passage member 21A and the communication hole 36 formed in the case head 20A.

The flow passage member 21A according to this embodiment is fixed to the base end portion of the respective piezoelectric elements 17. In addition, a driving circuit 60 of the flexible printed board 50 electrically connected to the piezoelectric elements 17 is connected to the flow passage member in the thermally conductive manner.

Even such a configuration, like the above-described first embodiment, it is possible to reduce the size and cost of the driving circuit 60, since the heat of the driving circuit 60 can be dissipated through the flow passage member 21. Moreover, by effectively dissipating the heat of the driving circuit 60 it is possible to increase current to be applied to the driving circuit 60, thereby improving an ink ejection characteristic and an ability in continuous ejection of ink.

In this embodiment, the through-hole 35A of the flow passage member 21A is configured to form a part of the ink introduction passage 30A, but the invention is not particularly thereto. For example, the flow passage member 21A may be formed from a side of the wiring board 40 of the case head to the vibration plate 15. That is, the ink introduction passage 30A may be formed in only a supply member.

### Other Embodiments

The invention has been described with reference to embodiments, but a basic configuration of the invention is not limited to the described embodiments. For example, in the above-described first and second embodiments, one ink introduction passage 30 and one ink introduction passage 30A as the liquid introduction passage are provided in the case heads 20 and 20A and the flow passages members 21 and 21A, respectively, but the invention is not particularly thereto. For example, two or more liquid introduction passages may be provided. With such a configuration, since a contact area of the flow passage members 21 and 21A with ink becomes broader, it is possible to more effectively cool (dissipate the heat of) the driving circuit by the ink. In addition, in the above-described first embodiment, the groove 35 is provided on the side of the case head 20, but the invention is not particularly thereto. For example, the groove 35 may be provided on the side of the flow passage member 21 and the case head 20 may block the groove 35 of the flow passage member 21.

The ink jet recording head according to the above-described embodiments forms a part of a recording head unit including an ink flow passage communicating with an ink cartridge or the like and is mounted on an ink jet recording apparatus. FIG. 5 is a schematic diagram illustrating an example of the ink jet recording apparatus.

As shown in FIG. 5, recording head units 1A and 1B having the ink jet recording head are provided so that cartridges 2A and 2B forming ink supply means are detachably mounted, respectively. A carriage 3 mounting the recording head units 1A and 1B is provided in a carriage shaft 5 mounted in an apparatus body 4 so as to be movable in a shaft direction. The recording head units 1A and 1B are configured to eject black ink and color ink, respectively, for example.

When a driving force of a driving motor 6 is delivered to the carriage 3 through a plurality of toothed-gears (not shown) and a timing belt 7, the carriage 3 mounting the recording head units 1A and 1B is moved along the carriage shaft 5. On the other hand, the apparatus body 4 is provided with a platen 8 along the carriage shaft 5. A recording sheet S as a recording medium such as a paper sheet fed by a sheet feeding roller (not shown) is wound by the platen 8 to be transported.

Moreover, in the above-described first and second embodiments, the ink jet recording head has been described as the liquid jet head, but the invention is aimed to broadly cover the overall liquid jet head and is also applicable to a liquid jet head ejecting a liquid other than ink. Examples of other liquid jet heads include various recording heads used for an image recording apparatus such as a printer, a coloring-material jet head used to manufacture a color filter of a liquid crystal display or the like, an electrode-material jet head used to form an electrode of an organic EL display, an FED (field emission display) or the like, a bioorganic-material jet head used to manufacture a biochip, and the like.

What is claimed is:

1. A liquid jet head comprising:
a pressure generation chamber communicating with a nozzle opening ejecting a liquid;
a piezoelectric element causing pressure change inside the pressure generation chamber;
a case head having an accommodation portion accommodating the piezoelectric element; and
a flexible printed board having a driving circuit mounted thereon and connected to the piezoelectric element to drive the piezoelectric element,
wherein the accommodation portion of the case head is provided with a flow passage member holding a base end portion of the piezoelectric element and being connected to the driving circuit in a thermally conductive manner, the case head is provided with a liquid introduction passage for supplying the liquid to the pressure generation chamber, and the flow passage member partitions a part of at least a wall surface of the liquid introduction passage.

2. The liquid jet head according to claim 1, wherein the flow passage member is formed of a material having thermal conductivity higher than that of the case head.

3. The liquid jet head according to claim 1, wherein the liquid introduction passage is partitioned by a groove opened to a side surface of the accommodation portion of the case head and the flow passage member blocking the groove.

4. The liquid jet head according to claim 1, wherein the liquid introduction passage is perforated through the flow passage member.

5. A liquid jet apparatus comprising the liquid jet head according to claim 1.
